(19) United States
(12) Patent Application Publication
(10) Pub. No.: US 2016/0140470 A1
(43) Pub. Date: May 19, 2016

(54) SYSTEMS AND METHODS FOR DETERMINING LEAD-TIME OFFSET VALUES

(71) Applicant: Caterpillar Inc., Peoria, IL (US)

(72) Inventors: Joseph R. HERRON, Farmington, IL (US); Yamin Z. MOHAMMED, Peoria, IL (US)

(73) Assignee: Caterpillar Inc., Peoria, IL (US)

(21) Appl. No.: 14/543,216

(22) Filed: Nov. 17, 2014

(51) Int. Cl. G06Q 10/06; G06Q 10/08

(52) U.S. Cl. CPC G06Q 10/06315; G06Q 10/087

(57) ABSTRACT

Systems and methods are disclosed for optimizing inventory using lead-time offset values. According to certain embodiments, a master routing, master component inventory, and routing report are received. An earliest required lead-time offset value for each component in the master component inventory is determined, and the earliest required lead-time offset value for each component in the master component inventory is compared to the planned lead-time offset value for the component. Each component for which the earliest required lead-time offset value is greater than the planned lead-time offset value is identified, and the planned lead-time offset value for each identified component is set to the earliest required lead-time offset value for the component.

### TECHNICAL FIELD

The present disclosure generally relates to systems and methods for optimizing inventory and, more particularly, to systems and methods for optimizing inventory by determining lead-time offset values (LTOVs) for components of an assembly.

### BACKGROUND

Material requirements planning (MRP) is a system used to manage manufacturing processes. Among other things, MRP systems manage inventory of components used in a manufacturing process. More specifically, MRP systems ensure that the components necessary to a manufacturing process are available for planned usage in the process. These systems can be used to optimize inventory levels for products by aiming to maintain the lowest possible number of components in inventory at any given time. Moreover, these systems may coordinate other actions related to the manufacturing process, such as supply chain activities.

Existing MRP systems attempt to prevent holdup in the manufacturing process by ensuring that there is sufficient inventory of the components required during the process. Manufacturers rely on these systems to determine when to order the parts needed for their manufacturing processes. These existing systems, however, do not give due consideration to the point at which a component is consumed in a lengthy manufacturing process. Thus, these systems may cause manufacturers to request or order components or raw materials from suppliers much earlier than those components or raw materials are needed by the manufacturers. This results in excess inventory, which raises the overall cost of the manufacturing process.

One technique for addressing the problem of excess inventory is described in U.S. Pat. No. 7,058,587. The '587 patent describes the use of a lead-time offset to delay the issuing of parts until the point of consumption in the manufacturing process. According to the '587 patent, applying a lead-time offset is useful for expensive components that are used late in the manufacturing process and/or when the manufacturing process is long.

Although the '587 patent explains how a lead-time offset may be used to reduce excess inventory, the '587 patent fails to disclose how a lead-time offset may be applied in a manner that optimizes inventory for planned sales orders. For example, the '587 patent fails to describe how to apply lead-time offsets on a per model basis for planned sales orders. The '587 patent further fails to describe how to maintain appropriate lead-time offsets in a changing manufacturing process or how to validate the lead-time offsets of the components involved in the process.

The present disclosure is directed to overcoming one or more of the problems set forth above and/or other problems in the art.

### SUMMARY OF THE INVENTION

In one aspect, the present disclosure is directed to a system for optimizing inventory, including a memory that stores a set of instructions and at least one processor in communication with the memory and configured to execute the set of instructions to perform certain steps. The processor is configured to receive a master routing that includes a sequence of events spanning a plurality of days. The processor is also configured to receive a master component inventory that includes a plurality of components and a planned lead-time offset value for each component. Moreover, the processor is configured to receive a routing report that allocates at least one of the plurality of components to the master routing. The processor is further configured to determine the earliest required lead-time offset value for each component in the master component inventory and compare the earliest required lead-time offset value for each component in the master component inventory to the planned lead-time offset value for the component. The processor is configured to identify each component for which the earliest required lead-time offset value is greater than the planned lead-time offset value and set the planned lead-time offset value for each identified component to the earliest required lead-time offset value for the component.

In another aspect, the present disclosure is directed to a non-transitory computer-readable storage medium storing instructions for optimizing inventory. The instructions cause the at least one processor to perform operations including receiving a master routing that includes a sequence of events spanning a plurality of days. The operations further include receiving a master component inventory that includes a plurality of components and a planned lead-time offset value for each component. Further, the operations include receiving a routing report that allocates at least one of the plurality of components to the master routing. An earliest required lead-time offset value for each component in the master component inventory is determined, and the earliest required lead-time offset value for each component in the master component inventory is compared to the planned lead-time offset value for the component. Each component for which the earliest required lead-time offset value is greater than the planned lead-time offset value is identified, and the planned lead-time offset value for each identified component is set to the earliest required lead-time offset value for the component.

### BRIEF DESCRIPTION OF THE DRAWINGS

FIG. 1 is an illustration of an exemplary system environment for optimizing inventory;

FIG. 2 is a flow chart illustrating an exemplary disclosed method of optimizing inventory; and

FIG. 3 is another flow chart illustrating another exemplary disclosed method of optimizing inventory.

### DETAILED DESCRIPTION

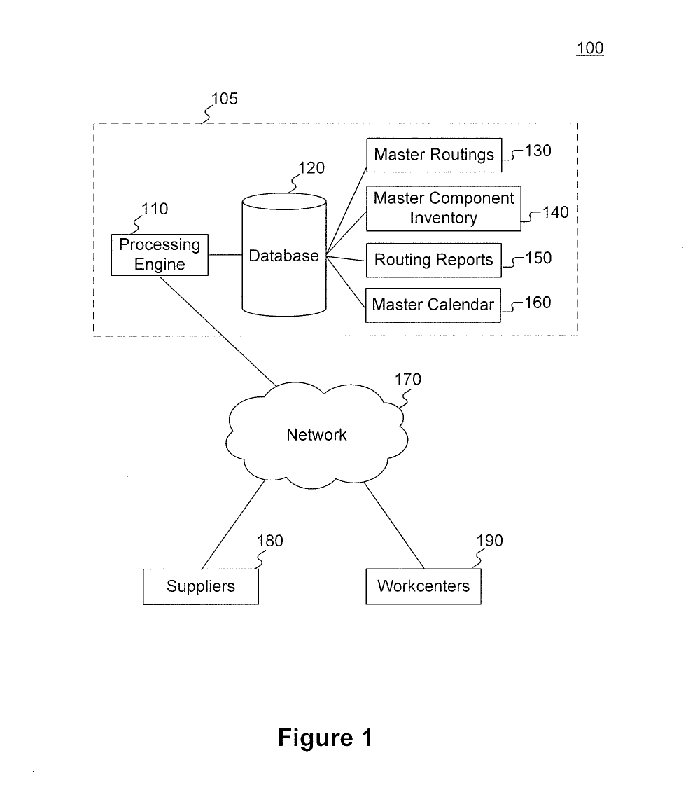

FIG. 1 depicts an exemplary system environment 100 for optimizing inventory. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a system 105. System 105 may include one or more server systems, databases, and/or computing systems configured to receive information from entities over a network and process and/or store the information. In one embodiment, system 105 may include a processing engine 110 and one or more databases 120, which are illustrated in a region bounded by a dashed line for system 105 in FIG. 1.

In one embodiment, system 105 may transmit and/or receive data to/from various other components of system environment 100, such as one or more suppliers 180 and workcenters 190. More specifically, system 105 may be configured to receive and store data transmitted over an electronic network 170 (e.g., comprising the Internet) from various data sources, including suppliers 180 and workcenters 190, process and/or store the received data, and transmit the processed data over the electronic network to consumers of the data, which may include suppliers 180 and workcenters 190, among others.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, system 105 may be configured to receive data over electronic network 170 and store the data. For example, system 105 may receive data over electronic network 170 from suppliers 180, which may supply components or raw materials used in one or more manufacturing processes. For example, system 105 may receive information from suppliers 180 regarding components or raw materials available for purchase from supplier 180, including component identifier, cost, lead time (i.e., expected time it takes to ship the component calculated from order date), and inventory (i.e., number of components currently available).

System 105 may also receive data over electronic network 170 from workcenters 190. Workcenters 190 may represent physical or logical subdivisions within one or more manufacturing facilities that are responsible for one or more stages of an assembly process. System 105 may receive information from workcenters 190 regarding the assembly of one or more machines, such as necessary parts (e.g., bill of materials (BOM)), current inventory, demand, routings, labor information (e.g., days assemblers are available to work on an assembly), and workcenter responsibilities (e.g., a description of a workcenter's responsibilities with respect to an assembly).

In one embodiment, system 105 may store data received over electronic network 170 from suppliers 180, workcenters 190, and other sources in one or more databases 120. In an alternate embodiment, system 105 may store data received over electronic network 170 from suppliers 180, workcenters 190, and other sources in other memory associated with processing engine 110, including local memory of processing engine 110 or remote storage (e.g., a remote server in communication with processing engine 110 (not shown)). Database 120 may be any suitable combination of large scale data storage devices, which may optionally include any type or combination of slave databases, load balancers, dummy servers, firewalls, back-up databases, and/or any other desired database components. For example, processing engine 110 may receive information regarding the cost, inventory, and lead time for components from suppliers 180 and store this information in database 120. Processing engine 110 may receive information regarding the assembly process, such as necessary components, inventory, demand, routings, labor information, and workcenter responsibilities, from workcenters 190 and store this information in database 120. Processing engine 110 may further associate the information received from suppliers 180 and workcenters 190 with various tables or components of database 120, such as master routings 130, master component inventory 140, routing reports 150, and master calendar 160. For example, processing engine 110 may associate routing information received from workcenters 190 with master routings 130 and/or routing reports 150, component inventory and bill of material information with master component inventory 140 and routing reports 150, and labor information with master calendar 160. Processing engine 110 may associate component supply information received from suppliers 180, such as component inventory (at the supplier), lead time, and cost, with master component inventory 140.

According to certain embodiments, database 120 stores master routings 130, master component inventory 140, routing reports 150, and master calendar 160. This information is used by system 105 to optimize inventory by determining, adjusting, and validating lead-time offset values, according to one or more of the embodiments disclosed herein.

Master routings 130 may include one or more master routings associated with one or more models produced by a manufacturer. In one embodiment, each master routing includes a sequence of events associated with the assembly of a model. For example, a master routing for a Model 1 Tractor may include a sequence of events associated with the assembly of the Model 1 Tractor, such as assembly of the engine, assembly of the frame, etc. In one embodiment, each of the events in the sequence of events may be associated with a date in the assembly process. For example, the first event may be assigned to the start date (e.g., day 0) and later events in the assembly process may be assigned to later dates (e.g., days 1 through X).

Master component inventory 140 may include an identification of each component used by a manufacturer to assemble any model of a product sold by the manufacturer. For example, if a manufacturer sells 10 tractor models, master component inventory 140 would include an identification of each component used by the manufacturer to assemble any of the 10 tractor models, regardless of whether the component is used in each model or only a subset of models. In one embodiment, master component inventory 140 includes an identification of each component involved in assembly of any model, as well as component cost, inventory (i.e., number of units in stock), lead time, planned lead-time offset value, and associated attachment information.

The lead time of a component is the amount of time that it takes the manufacturer to receive a component from a supplier from the time an order for that component is placed. The planned lead-time offset value offsets the lead time for a component by a time based on the point at which the component is consumed in the assembly process. For example, if a component is first used on day 7 of the assembly process, the lead-time offset value for the component may be 7 (or 7 days).

In some embodiments, components of an assembly are associated with one or more attachments. An attachment is a multi-component subpart of an assembly. For example, a truck engine attachment may be comprised of various components. These components may also be used in other attachments within the truck as well. Moreover, different engine attachments (e.g., V6, V8, V12 engines) may be used for different truck models produced by a manufacturer. In one embodiment, the lead-time offset value for a component may be based on a lead-time offset value associated with an attachment associated with the component and/or the lead-time offset values associated with other components associated with the same attachment.

Routing reports 150 describe the process for assembling one or more models. In one embodiment, a routing report 150 allocates components from master component inventory 140 to a master routing 130. Thus, a routing report 150 may associate each of the components needed to build a model with an event in the assembly process for the model. More specifically, a routing report 150 may associate each of the components in master component inventory 140 with a requirement date corresponding to a date on which the component is forecasted to be consumed in the assembly process for a given model. In some embodiments, the requirement date for a component may be based on a requirement date of an attachment associated with the component or on a requirement date of another component associated with the same attachment. The requirement date may be used to calculate an earliest required lead-time offset value for each component.

Master calendar 160 describes the dates on which work can be performed by various entities associated with a manufacturer. For example, master calendar 160 may allocate work associated with a work area within a manufacturing plant to certain dates. Master calendar 160 may indicate days on which entities within a manufacturing plant are unavailable to perform work, such as weekends, holidays, and days on which the entities are already assigned to perform other work. In one embodiment, master calendar 160 is used to schedule dates corresponding to future assembly of planned or existing sales orders by the manufacturer.

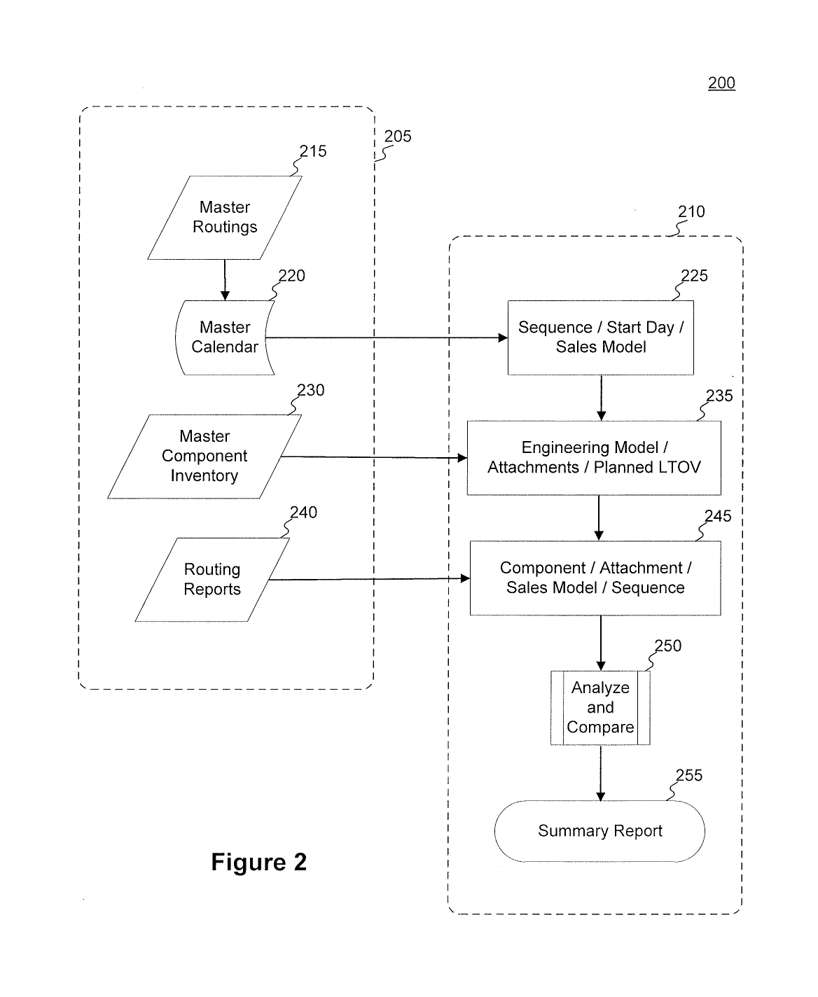

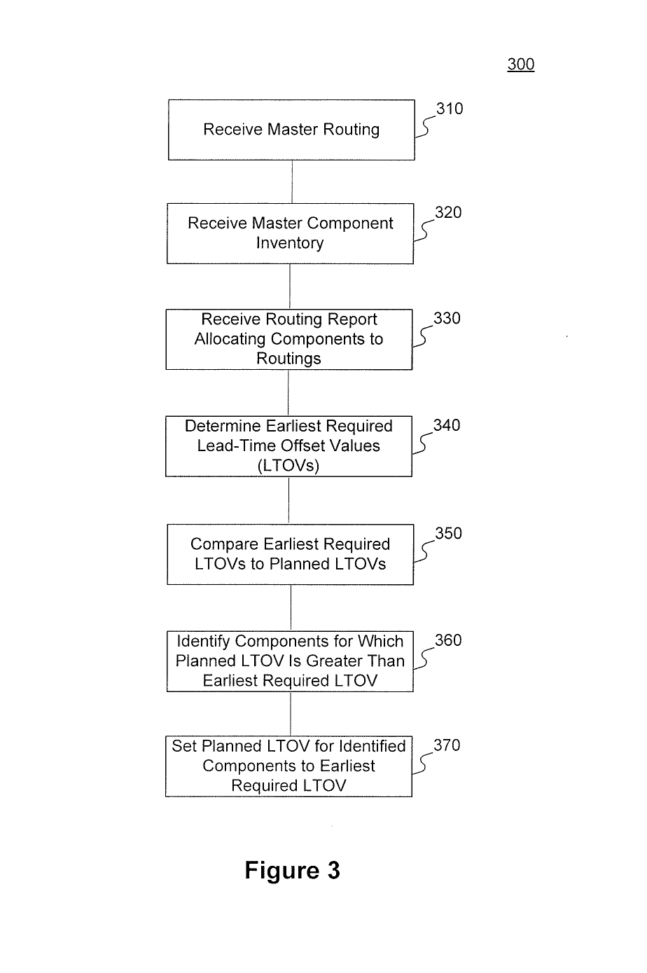

In accordance with certain embodiments, processing engine 110 receives master routings 130, master component inventory 140, routing reports 150, and/or master calendar 160 from database 120 and processes this information to determine, adjust, and validate lead-time offset values. In one embodiment, processing engine 110 compares the planned lead-time offset values associated with components in master component inventory 140 to the earliest required lead-time offset values for those components, as determined based on master routings 130 and/or routing reports 150. Based on this comparison, processing engine 110 may update the planned lead-time offset values for one or more components, which may lead to a reduction in excess inventory for components stored by the manufacturer. FIGS. 2 and 3, discussed below, provide further detail regarding techniques for determining, adjusting, and validating lead-time offset values to reduce excess inventory.

### INDUSTRIAL APPLICABILITY

The disclosed systems and methods for optimizing inventory may be utilized to improve the efficiency of manufacturing processes. In particular, the disclosed systems and methods may reduce excess inventory of components utilized during a manufacturing process by determining, adjusting, and validating lead-time offset values associated with the components. In particular, the application of lead-time offset values to components adjusts the time at which components are ordered from suppliers, such that the components are received by the manufacturer close in time to the point at which the components are consumed in the manufacturing process. By applying the disclosed techniques, manufacturers may reduce costs associated with storing components prior to their consumption.

FIG. 2 depicts an exemplary flow of a process 200 for optimizing inventory by determining, adjusting, and validating lead-time offset values, in accordance with an embodiment of the present disclosure. The steps associated with this exemplary process may be performed by the components of FIG. 1. For example, the steps associated with the exemplary process of FIG. 2 may be performed by processing engine 110 and/or database 120 of system 105 illustrated in FIG. 1.

The steps associated with process 200 may be performed using manufacturing resource planning (MRP) software, word processing software, spreadsheet software, and/or any other combination of software for storing, organizing, and presenting information related to manufacturing processes. The steps within region 205 generally relate to receipt or collection of data from MRP software, databases, or local files. The steps within region 210 generally relate to processing, analysis, and/or presentation of the collected data utilizing word processing and/or spreadsheet software, including scripting functionality.

In step 215, processing engine 110 may receive one or more master routings 130. As discussed above, each master routing 130 describes a sequence of events associated with the assembly of a model. In one embodiment, each event in the sequence of events in a master routing 130 may be assigned to a date, which may relative to an undefined start date. Processing engine 110 receives a master calendar 160 at step 220. In one embodiment, master calendar 160 indicates when work can be performed by one or more persons or other entities associated with a workcenter 190 of a manufacturing facility. Processing engine 110 may use master routings 130 and master calendar 160 to determine a start date for assembly of one or more models at step 225. In one embodiment, processing engine 110 may generate and store a spreadsheet or other structure representing a start date and assembly sequence associated with a sales model at step 225.

Processing engine 110 may receive a master component inventory 140 at step 230. As discussed above, master component inventory 140 includes information pertaining to each component utilized by a manufacturer in the assembly of any model. Among other things, master component inventory 140 includes a planned lead-time offset for each component. Processing engine 110 may use information received and/or selected from master component inventory 140 at step 235 to generate and store a spreadsheet or other structure representing the planned lead-time offset value for each component utilized during assembly of a model, organized on a per attachment per engineering model basis. An engineering model is a lower-level instantiation of a sales model. For example, an automobile manufacturer may have one sales model corresponding to one automobile model, with separate engineering models for that model corresponding to the sedan, coupe, and convertible lines of the model. Each engineering model may be comprised of various attachments, which in turn may be comprised of multiple components.

In step 240, processing engine 110 may receive one or more routing reports 150. As discussed above, each routing report 150 may allocate components from master component inventory 140 to one or more routings (e.g., from master routings 130). In one embodiment, processing engine 110 may generate and store a spreadsheet or other structure correlating each sales model with a sequence of events and one or more components and/or attachments allocated to the events at step 245.

Processing engine 110 may analyze and compare the information stored in steps 225, 235, and 245 at step 250. At step 255, processing engine 110 generates a summary report that indicates, for each engineering model, the earliest required lead-time offset value for each component and/or attachment involved in the assembly of the engineering model. Processing engine 110 may use this information to adjust the planned lead-time offset value stored for one or more components in master component inventory 140. More specifically, processing engine may set the planned lead-time offset value for one or more components in master component inventory 140 equal to the earliest required lead-time offset value for the corresponding component, as determined in step 255. Processing engine may then rerun steps 215 through 255 to verify that the planned lead-time offsets for all components in master component inventory 140 are at least as great as the earliest required lead-time offset for each component.

FIG. 3 depicts an exemplary flow of a process 300 for optimizing inventory by determining, adjusting, and validating lead-time offset values, in accordance with an embodiment of the present disclosure. The steps associated with this exemplary process may be performed by the components of FIG. 1. For example, the steps associated with the exemplary process of FIG. 3 may be performed by processing engine 110 and/or database 120 of system 105 illustrated in FIG. 1.

In step 310, a master routing is received. The master routing may comprise a sequence of events spanning a plurality of days. In one embodiment, the master routing comprises a sequence of events for assembling a machine. In step 320, a master component inventory is received. The master component inventory may comprise a plurality of components and a planned lead-time offset value for each component. In one embodiment, the master component inventory identifies each component used to assemble a machine. In step 330, a routing report is received. The routing report may allocate at least one of the plurality of components to the master routing.

In one embodiment, the routing report associates each component in the master component inventory with a requirement date based on the master routing, the requirement date being one of the plurality of days spanned by the sequence of events. Further, one or more components in the master component inventory may be associated with attachments. In one embodiment, the requirement date of a component associated with an attachment is based on a requirement date of the attachment.

In one embodiment, a calendar is received and a start date is determined based on the master routing and the calendar. The calendar may indicate a plurality of dates on which an even in the sequence of events can be performed. The start date is a future date for initiating the sequence of events.

In step 340, an earliest required lead-time offset value is determined for each component in the master component inventory. The earliest required lead-time offset value for each component in the master component inventory is compared to the planned lead-time offset value for the component in step 350. In step 360, each component for which the earliest required lead-time offset value is greater than the planned lead-time offset value is identified. The planned lead-time offset value for each identified component is set to the earliest required lead-time offset value for the component at step 370.

In one embodiment, a report is generated comprising each of the identified components and the planned lead-time offset value and the earliest required lead-time offset value associated with each component. Further, in one embodiment, a request for a component may be transmitted over an electronic network to a supplier based on the earliest required lead-time offset value associated with the component.

Several advantages over the prior art may be associated with the disclosed systems and methods for optimizing inventory. Unlike the techniques described in the prior art, the disclosed techniques for determined lead-time offset values may be applied to maintain appropriate lead-time offsets as a manufacturing process changes. Moreover, the disclosed techniques may be utilized to validate planned lead-time offset values by comparing those values to the earliest required lead-time offset for a component.

It will be apparent to those skilled in the art that various modifications and variations can be made to the disclosed systems and methods for optimizing inventory. Other embodiments will be apparent to those skilled in the art from consideration of the specification and practice of the disclosed systems and methods for optimizing inventory. It is intended that the specification and examples be considered as exemplary only, with a true scope being indicated by the following claims and their equivalents.

What is claimed is:

1. A system for optimizing inventory, comprising:
a memory that stores a set of instructions; and
at least one processor in communication with the memory and configured to execute the set of instructions to:
receive a master routing, wherein the master routing comprises a sequence of events spanning a plurality of days;
receive a master component inventory, wherein the master component inventory comprises a plurality of components and a planned lead-time offset value for each component;
receive a routing report, wherein the routing report allocates at least one of the plurality of components to the master routing;
determine an earliest required lead-time offset value for each component in the master component inventory;
compare the earliest required lead-time offset value for each component in the master component inventory to the planned lead-time offset value for the component;
identify each component for which the earliest required lead-time offset value is greater than the planned lead-time offset value; and
set the planned lead-time offset value for each identified component to the earliest required lead-time offset value for the component.

2. The system of claim 1, wherein the master routing includes a sequence of events for assembling a machine.

3. The system of claim 2, wherein the master component inventory identifies each component used to assemble the machine.

4. The system of claim 1, wherein the routing report associates each component in the master component inventory with a requirement date based on the master routing, the requirement date being one of the plurality of days spanned by the sequence of events.

5. The system of claim 4, wherein a first component in the master component inventory is associated with an attachment.

6. The system of claim 5, wherein the requirement date of the first component is based on a requirement date of the attachment.

7. The system of claim 1, wherein the processor is further configured to:
receive a calendar; and
determine a start date based on the master routing and the calendar.

8. The system of claim 7, wherein the calendar indicates a plurality of dates on which an event in the sequence of events can be performed.

9. The system of claim 7, wherein the start date is a future date for initiating the sequence of events.

10. The system of claim 1, wherein the processor is further configured to generate a report comprising each of the identified components and the planned lead-time offset value and the earliest required lead-time offset value associated with each component.

11. The system of claim 1, wherein the processor is further configured to transmit to a supplier, over an electronic network, a request for a component based on the earliest required lead-time offset value associated with the component.

12. A non-transitory computer-readable storage medium storing instructions for optimizing inventory, the instructions causing at least one processor to perform operations comprising:
receiving a master routing, wherein the master routing comprises a sequence of events spanning a plurality of days;
receiving a master component inventory, wherein the master component inventory comprises a plurality of components and a planned lead-time offset value for each component;
receiving a routing report, wherein the routing report allocates at least one of the plurality of components to the master routing;
determining an earliest required lead-time offset value for each component in the master component inventory;
comparing the earliest required lead-time offset value for each component in the master component inventory to the planned lead-time offset value for the component;
identifying each component for which the earliest required lead-time offset value is greater than the planned lead-time offset value; and
setting the planned lead-time offset value for each identified component to the earliest required lead-time offset value for the component.

13. The non-transitory computer-readable storage medium of claim 12, wherein the routing report associates each component in the master component inventory with a requirement date based on the master routing, the requirement date being one of the plurality of days spanned by the sequence of events.

14. The non-transitory computer-readable storage medium of claim 13, wherein a first component in the master component inventory is associated with an attachment.

15. The non-transitory computer-readable storage medium of claim 14, wherein the requirement date of the first component is based on a requirement date of the attachment.

16. The non-transitory computer-readable storage medium of claim 12, wherein the instructions further cause the at least one processor to:
receive a calendar; and
determine a start date based on the master routing and the calendar.

17. The non-transitory computer-readable storage medium of claim 16, wherein the calendar indicates a plurality of dates on which an event in the sequence of events can be performed.

18. The non-transitory computer-readable storage medium of claim 16, wherein the start date is a future date for initiating the sequence of events.

19. The non-transitory computer-readable storage medium of claim 12, wherein the instructions further cause the at least one processor to generate a report comprising each of the identified components and the planned lead-time offset value and the earliest required lead-time offset value associated with each component.

20. The non-transitory computer-readable storage medium of claim 12, wherein the instructions further cause the at least one processor to transmit to a supplier, over an electronic network, a request for a component based on the earliest required lead-time offset value associated with the component.
